(19) United States
(12) Patent Application Publication
(10) Pub. No.: US 2019/0070737 A1
(43) Pub. Date: Mar. 7, 2019

(54) FOLDING-BLADE KNIFE

(71) Applicant: Francis LEPAGE, Dommartin (FR)

(72) Inventor: Francis LEPAGE, Dommartin (FR)

(21) Appl. No.: 16/083,910

(22) PCT Filed: Mar. 6, 2017
(86) PCT No.: PCT/FR2017/050492

§ 371 Date: Sep. 11, 2018

(30) Foreign Application Priority Data
Mar. 17, 2016 (FR) 1652251

(51) Int. Cl. B26B 1/02

(52) U.S. Cl. CPC B26B 1/02

(57) ABSTRACT

This folding-blade knife comprises a handle defining a recess within which a blade, articulated close to one of the ends of the handle, can be stowed. Integrated into the handle are: a first means for locking the blade in the folded position in order to prevent unintended egress of the blade from the handle; close to the region where the blade is articulated to the handle, a second means for unlocking said first locking means, said second means being actuable by the user, and a third means to cause the blade to rotate about its articulation axis once unlocked.

### TECHNICAL FIELD

The invention relates to a knife, and particularly to a pocket knife, with a folding blade, provided with a system of assisted opening of the blade.

More particularly, the blade, hinged to the knife handle, is capable of lodging itself in a recess provided for this purpose within said handle, or of sliding on the handle. The invention more specifically aims at a device enabling to induce the coming out of the blade from such a recess, with a variable amplitude, to then ease the positioning of the blade by the user according to its operating position.

### BACKGROUND

Folding blade knives have existed for a long time and are very widespread. They allow, due to the positioning in folded position of the sharp area of the blade within the handle, a secure transportation, particularly in a pocket of a clothing item.

However, knives of this type known to date have a number of disadvantages, among which the following can be mentioned:
the locking of the blade in operating, that is, unfolded, position is for example ensured by means of various devices, such as for example a rotating ferrule positioned in the vicinity of the area where the blade is hinged to the handle, a spring leaf used as a pin to be loaded, and generally as a resistance point, or also the system well known as “liner lock” and formed of a spring leaf integrated within the handle and which acts against the blade or against a shoulder formed in the vicinity of the base of the blade: whatever the locking system thus used, the blade unlocking appears over time to be uneasy, often due to the power of said means, which unlocking may require using both hands, and that, further, for some of these systems, the knife position is inverted;
such a locking may also be performed by a system which compresses an opening spring (switchblade knife type). The actual locking results from the cooperation of a pin with a shape formed within the blade. Such a system enables to automate the blade opening and, further, to avoid an untimely folding of the blade, and thus accordingly risks of cutting injuries. However, the knife thus formed appears to be dangerous due to the abruptness of the opening, which has for that matter led the French administration to classifying it as a fourth-category weapon, the possession of which is severely restricted;
the locking of the blade in closed position or the simple holding of the blade in this position, to avoid any untimely opening of the blade, often results from the use of a spring or of locking points: experience shows that the taking out of the blade from the handle is difficult precisely due to such a spring or to such a locking system, despite the presence, sometimes, of a groove formed on the blade edge, where the end of a nail can be inserted.

The am of the invention is to favor the use of such folding blade knives by providing them with a device capable, on request by the user, of generating the partial or total opening of the blade, typically by some twenty degrees with respect to the longitudinal axis of the handle, to enable the user to grab the blade to position it in operational mode, that is, to totally unfold it, or even to enable the blade to unfold by itself, that is, with no intervention of the user.

The invention also aims at the possibility of adding to such a knife a device for attenuating the effects of the means enabling to open the blade, intended to decrease or even to cancel the aggressiveness resulting from too fast a coming out or a deployment of the blade.

### SUMMARY OF THE INVENTION

For this purpose, the invention relates to a folding blade knife, comprising a handle defining a recess into which a blade, hinged in the vicinity of one of the ends of the handle, is capable of retracting.

According to the invention, the handle integrates:
first means capable of locking the blade in folded position to avoid an untimely coming out of said blade from the handle;
in the vicinity of the area where the blade is hinged to the handle,
   second means capable of unlocking said first locking means, said second means being operable by the user,
   third means capable of inducing the rotation of the blade around its hinge axis after it has been unlocked.

According to a feature of the invention, the handle also comprises additional means capable of limiting the speed of the rotation or of the coming out of the blade from the handle during the unlocking action.

In other words, the invention comprises fitting a folding blade knife with:
a member for locking the blade in closed position, that is, in a position retracted within the handle, said means being capable of being unlocked by actuation by the user simultaneously inducing the effective unlocking of the blade and the partial or total coming out thereof from the slot or the recess formed within the handle, and
a member capable of limiting the rotation speed of the blade or the amplitude by which the blade comes out of the handle after the unlocking, this, to optimize the user safety on opening of said blade.

Thereby, said blade being submitted to a limited rotation, typically by some twenty degrees with respect to the longitudinal axis of the handle, the user can grab it, particularly at the level of its free end, without risking to cut him- or herself and with no difficulty, to totally unfold it and position it in operating mode.

According to the invention, the handle comprises two plates extending substantially along the entire length of the slot that it defines. One of these plates has a leaf spring provided with a lug capable of cooperating with a recess provided for this purpose within the base of the blade to hold it in locked position, the leaf spring being capable of cooperating with an unlocking member (the second means) operable by the user and provided in the vicinity of the area where the blade is hinged to the handle.

According to the invention, said plate comprises a second leaf spring, also provided with a lug capable of cooperating with a recess provided for this purpose within the base of the blade, and intended to limit the rotation amplitude of the blade once the latter has been unlocked.

According to the invention, the third means capable of generating the rotation of the blade are formed of a spring leaf, folded on itself, thus defining two branches, one of which is fastened to a spacer separating the two plates and the other one of which bears against the blade.

According to the invention, the knife may comprise at least one means for slowing down or damping the blade rotation. These means are for example formed by at least one compressible spring lock washer, typically made of stainless steel, coaxially associated with the blade hinge axis, the washer being capable of slowing down the blade rotation under the effect of said spring by friction. The spring lock washer may be reduced to a simple washer portion, and for example to half a washer.

As a variation, the slowing down may result from the second previously-mentioned spring lock washer, which according to the spring effect which is provided thereto by construction may be sufficient to ensure the slowing down function.

Thereby, the security of such a knife is optimized by limiting risks of injury at the coming out of the blade.

According to another feature of the invention, the blade hinge area comprises a spiral spring assembled coaxially to the blade hinge axis and cooperating therewith, the spring action being released when the unlocking member is operated by the user, then causing the rotation of the blade and its coming out of the handle slot, and possible the full unfolding of the blade.

### BRIEF DESCRIPTION OF THE DRAWINGS

The way in which the invention can be implemented and the resulting advantages will better appear from the following non-limiting embodiments, in relation with the accompanying drawings, where the same reference numerals designate the same or like elements.

FIGS. 1, 2, and 3 illustrate the folding blade knife according to the invention in perspective view, respectively in closed position, in open and thus operating position, and in pre-opening position.

FIG. 4 is a simplified exploded view of the knife of the previous drawings in folded position (retracted blade).

FIG. 5 is a simplified representation of one of the two plates integrated in the handle of the knife of the invention.

FIGS. 6, 7, and 8 are partial simplified views of the knife of the invention, respectively in closed position, in pre-opening position, and in open and thus operating position.

FIG. 9 is a simplified representation of one of the surfaces of the blade of the knife of the invention.

FIG. 10 is a cross-section view of the knife of the invention is semi-unfolded position.

### DETAILED DESCRIPTION OF THE INVENTION

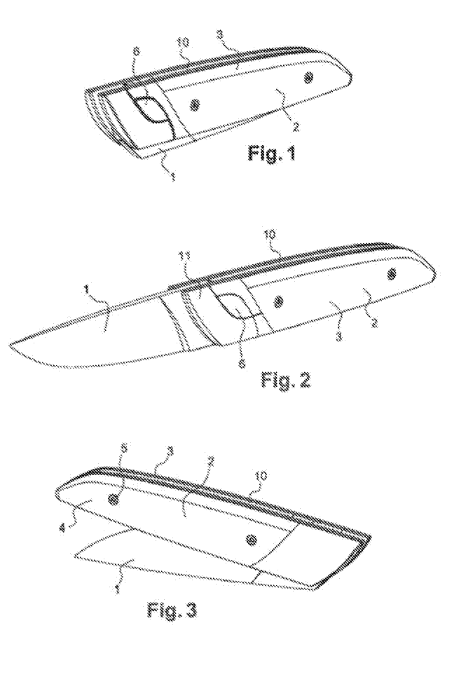

FIGS. 1, 2, and 3 schematically illustrate the knife according to the invention. It is of folding blade type, that is, the blade (1) fitting it, typically mad of stainless steel, is capable of folding into a recess formed within the handle (2).

The blade (1) is hinged in the vicinity of one of the ends of the handle (2) with respect to a hinge axis (7).

The handle (2) may be made of any material (wood, plastic . . . ). In the case in point, it typically comprises two external shells (3, 4) each fastened by screws (5) onto a respective inner plate (9, 8), themselves assembled together by means of a spacer (10). The plates define together the housing or slot intended to receive the blade (1).

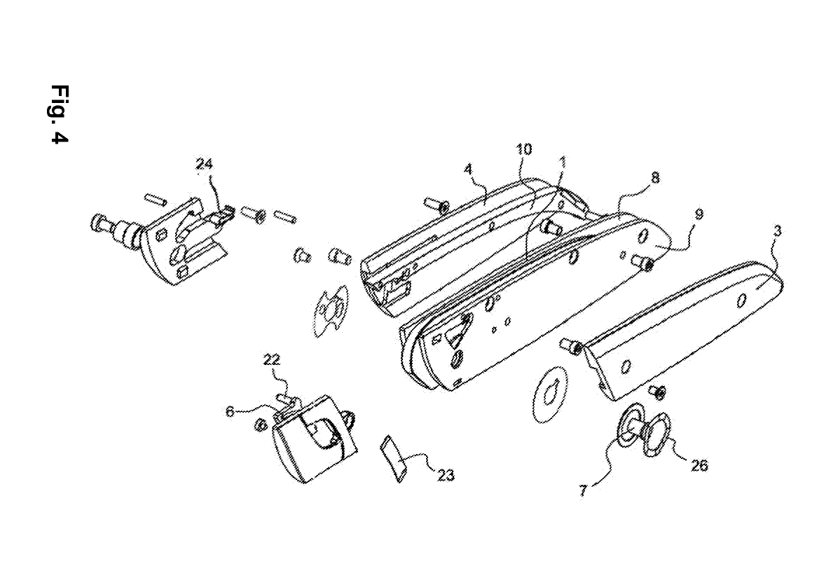

The position of the knife with the blade in pre-opening position, which is one of the features of the result to be achieved according to an embodiment of the invention, has been more specifically shown in FIG. 3.

A push button operable by the user by simple pressure and intended, according to the invention, to induce the pre-opening of the blade to obtain the result illustrated in FIG. 3 has been shown with reference numeral (6). The push button (6) is here again positioned in the vicinity of the area where the blade is hinged to the handle. More specifically, the push button (6) is integrated in a casing (11) continuing the shell (3) at the level of the area where the blade (1) is hinged, and fastened to the inner plates, also by means of screws, or of any other means, such as hooks.

FIG. 4 illustrates in exploded view the different components of the knife of the invention.

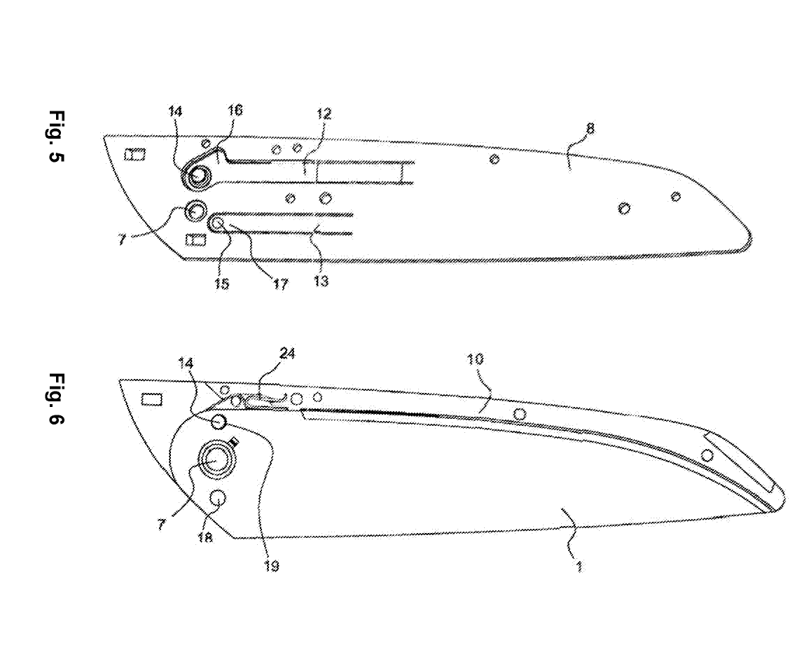

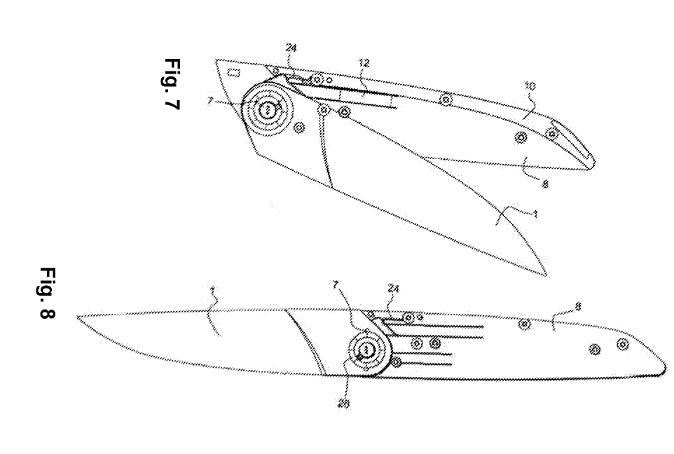

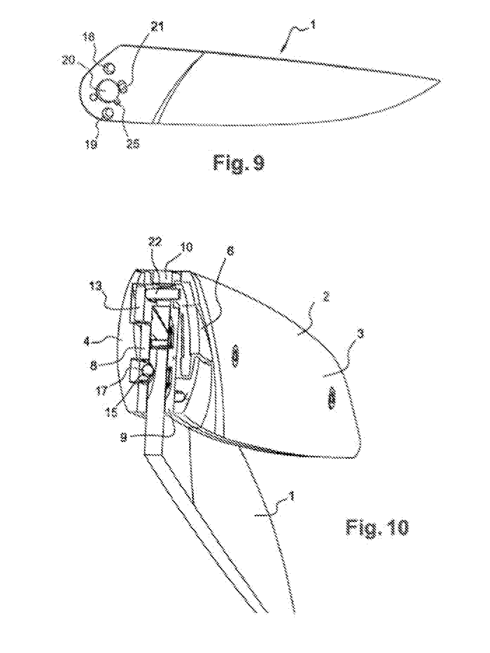

FIG. 5 shows in detail one (8) of the two plates. They are typically made of stainless steel. The two plates are parallel to each other and further to the general plane containing the blade (1).

Plate (8) plays an important role in the context of the invention. For this purpose, it is provided with two leaf springs, respectively (12) and (13), resulting from its cutting. The resilient character is provided to the two leaves by appropriate thermal treatment of the steel, which technique is well known per se in the considered field.

The free end (16) of the spring leaf (12) is provided on its surface directed towards the other plate (9) with a lug (14), directed towards plate (9) and intended to cooperate with two openings or recesses (18, 19) formed in the vicinity of the base of the blade (1), respectively when it is in totally unfolded position and in folded position. Thus, due to the spring effect of the leaf (12), the locking in closed position of the blade (1) within the slot of the handle (2) is ensured by cooperation of the lug (14) with the recess (19), avoiding any untimely opening of the blade. Accordingly, due to the same effect, the blade (1) is locked in open position by cooperation of the lug (14) with the recess (18). It can further be observed that the two recesses are, on the one hand, positioned at the same distance from the port (20) allowing the passage of the rotation axis (7) of the blade (1), and on the other hand, substantially diametrically opposite with respect to each other relative to the port. This can be explained by the fact that the travel amplitude of the blade is substantially 180°.

The unlocking of the blade (1) is obtained by operating a push button (6). The latter is provided with a lug (22) which bears against the end (16) of said leaf spring (12), thus releasing the lug (14) from its cooperation with the formed recess (18).

The push button (6) is submitted to the action of a spring leaf (23) fastened to the package (11) to induce, in the absence of stress, that is, when it is not operated by the user, its positioning in non-operating mode, that is, a mode which does not induce the release of the blade (1).

The first means capable of unlocking the blade when it is totally retracted within the handle has thus just been described.

The knife according to a first embodiment of the invention also comprises second means capable of allowing, when the blade (1) is unlocked after the push button (6) has been operated, the rotation thereof by some twenty degrees with respect to the longitudinal axis of the handle, to subsequently allow its grabbing by the user.

For this purpose and according to the invention, these means are for example formed of a spring leaf (24), folded on itself to define two branches. The free end of the first branch is fastened to the spacer (10) and the other branch bears against the blade (1). Indeed, and when the blade (1) is unlocked, said branch of the spring leaf (24) induces its rotation with respect to the hinge axis (7).

The amplitude of this rotation is however limited to some twenty degrees. For this purpose, the second leaf spring (13) of the plate (8) is provided with a lug (15), also directed towards the other plate (9). This lug (15) is intended to cooperate with an oblong recess or hole (21) formed at the base of the blade, the orientation of said hole being concentric to the rotation axis of the blade (1). Thus, by varying the length and/or the position of this hole, the possible aperture of the blade (1) after its unlocking is defined. Further, according to the intensity of the spring effect provided by construction to the leaf spring (13) and thus accordingly, according to the friction that its free end exerts on the blade (1), it may exert a slowing down action on said blade during the unlocking and accordingly limit the rotation amplitude of the blade and/or its rotation speed.

According to another embodiment of the invention, the unfolding of the blade is integral. For this purpose, the knife is further provided with a spiral spring (not shown), positioned coaxially to the blade hinge axis, having one of its points of application thereon formed by a radial slot (25) formed from the port (20) and having its other application point formed by the casing.

To limit too brutal an action of such springs (spring leaf (24) and spiral spring), the blade rotation is slowed down by means of at least one compressible spring lock washer (26) positioned at the level of the rotation axis thereof, thus providing a friction limiting the free rotation of the blade out of the handle when it is unlocked.

The implementation of such a slowing down system advantageously enables to oversize the spiral spring to have a perennial effect of the blade rotation.

The advantages of the knife of the present invention thus become apparent. First, it provides a relatively intense locking of the blade, respectively in closed position and in open position. Further, it provides the possibility of an ergonomic unlocking of the blade, by means of a simple push button ideally located when the knife is held in operating position.

Further, it enables to pre-open the blade safely and non aggressively.

1. A folding blade knife, comprising a handle defining a recess into which a blade, hinged in an area at one end of the handle, is capable of retracting, the handle integrating:
a first means capable of locking the blade in folded position to avoid an untimely opening of said blade from the handle;
near the area where the blade is hinged to the handle,
a second means capable of unlocking said first locking means, said second means being operable by a user,
a third means capable of inducing rotation of the blade around its hinge axis after it has been unlocked;
wherein the handle also integrates additional means capable of limiting speed of the rotation or of the opening of the blade from the handle and/or amplitude of the rotation of the blade out of the handle during the unlocking action.

2. The folding blade knife of claim 1, wherein the handle comprises two plates substantially extending along an entire length of a slot defined by said handle, one of these plates having a leaf spring provided with a lug capable of cooperating with a recess provided for this purpose within a base of the blade to hold it in locked position, the spring leaf being capable of cooperating with the second means.

3. The folding blade knife of claim 2, wherein the lug is capable of cooperating with a recess formed within the base of the blade to hold said blade in open position.

4. The folding blade knife of claim 2, wherein one of said plates comprises a second leaf spring, also provided with a lug capable of cooperating with a recess provided for this purpose within the base of the blade, and intended to limit the rotation amplitude of the blade once the latter has been unlocked.

5. The folding blade knife of claim 4, wherein said second leaf spring behaves as additional means capable of limiting the speed of the rotation or of the opening of the blade from the handle and/or of the rotation amplitude of the blade out of the handle during the unlocking action.

6. The folding blade knife of claim 1, wherein said additional means further comprise at least one compressible spring lock washer or a washer portion, positioned on the hinge axis of the blade, capable of slowing down the blade rotation under the effect of said spring by friction.

7. The folding blade knife of claim 1, wherein the third means capable of generating the rotation of the blade are formed of a spring leaf, folded on itself, thus defining two branches, one of which is fastened to a spacer separating and fastening together the two plates and the other one of which bears against the blade.
